(19) United States
(12) Patent Application Publication
(10) Pub. No.: US 2015/0052290 A1
(43) Pub. Date: Feb. 19, 2015

(54) DATA STORAGE DEVICE AND OPERATING METHOD THEREOF

(71) Applicant: SK hynix Inc., Gyeonggi-do (KR)

(72) Inventors: Gi Pyo UM, Gyeonggi-do (KR); Jong Ju PARK, Gyeonggi-do (KR)

(73) Assignee: SK hynix Inc., Gyeonggi-do (KR)

(21) Appl. No.: 14/055,582

(22) Filed: Oct. 16, 2013

(30) Foreign Application Priority Data
Aug. 13, 2013 (KR) 10-2013-0095899

(51) Int. Cl. G06F 3/06

(52) U.S. Cl. CPC G06F 3/0679; G06F 3/065; G06F 3/0619
USPC 711/103; 711/162

(57) ABSTRACT

An operating method of a data storage device includes comparing the number of address mapping table segments containing changed address mapping information with a backup reference value, and backing up the address mapping table segments containing the changed address mapping information in response to the comparison result.

### CROSS-REFERENCES TO RELATED APPLICATION

The present application claims priority under 35 U.S.C. §119(a) to Korean application number 10-2013-0095899, filed on Aug. 13, 2013, in the Korean Intellectual Property Office, which is incorporated herein by reference in its entirety.

### BACKGROUND

1. Technical Field

Various exemplary embodiments relate to a data storage device, and more particularly, to an operating method for improving performance of a data storage device.

2. Related Art

The recent paradigm for computer surroundings has changed into ubiquitous computing environments in which computer systems may be used anytime and anywhere. Thus, the use of portable electronic devices such as mobile phones, digital cameras, and notebook computers has rapidly increased. Such portable electronic devices generally employ a data storage device using a memory device. The data storage device is used as a main memory device or auxiliary memory device of the portable electronic devices.

Since the data storage device using a memory device has no mechanical driver, the data storage device has excellent stability and durability. Furthermore, the data storage device has high access speed and small power consumption. The data storage device having such advantages includes a universal serial bus (USB) memory device, a memory card having various interfaces, and a solid state drive (SSD).

A host device provides a logical address to access the data storage device. The data storage device converts the logical address into a physical address used in the data storage device, and performs a requested operation based on the physical address. For such an address conversion operation, the data storage device may manage an address mapping table. Furthermore, the data storage device may back up the address mapping table in a nonvolatile memory region so that the address mapping table is not lost.

### SUMMARY

Various exemplary embodiments are directed to an operating method for improving performance of a data storage device.

In an exemplary embodiment of the present invention, an operating method of a data storage device may include comparing the number of address mapping table segments containing changed address mapping information with a backup reference value, and backing up the address mapping table segments containing the changed address mapping information in response to the comparison result.

In an exemplary embodiment of the present invention, a data storage device may include a nonvolatile memory device, a volatile memory device suitable for storing an address mapping table divided into a plurality of address mapping table segments, in order to map a physical address of the nonvolatile memory device to a logical address provided from a host device, and a controller suitable for controlling the nonvolatile memory device based on the address mapping table loaded into the volatile memory device in response to a request from the host device, wherein the controller backs up address mapping table segments containing changed address mapping information into the nonvolatile memory device in response to a comparison result obtained by comparing the number of the address mapping table segments containing the changed address mapping information with a backup reference value.

In an exemplary embodiment of the present invention, a data storage device may include a nonvolatile memory device, and a controller suitable for controlling the nonvolatile memory device based on an address mapping table in response to a request from a host device, wherein the controller comprises a storage unit suitable for storing the number of address mapping table segments containing changed address mapping information, and a comparison unit suitable for comparing the number of the address mapping table segments containing the changed address mapping information with a backup reference value, wherein the controller dynamically performs a backup operation for the address mapping table in response to a comparison result from the comparison unit.

### BRIEF DESCRIPTION OF THE DRAWINGS

Features, aspects, and embodiments are described conjunction with the attached drawings, in which:

FIG. 1 is a block diagram illustrating a data processing system including a data storage device according to an exemplary embodiment of the present invention;

FIG. 2 is a flowchart explaining an operating method of a data storage device according to an exemplary embodiment of the present invention;

FIG. 3 is an address mapping table explaining address mapping table segments containing changed address mapping information according to an exemplary embodiment of the present invention;

FIG. 4 is a diagram explaining a dynamic backup operation for an address mapping table according to an exemplary embodiment of the present invention;

FIG. 5 is a block diagram illustrating a data processing system according to an exemplary embodiment of the present invention;

FIG. 6 is a block diagram illustrating an SSD according to an exemplary embodiment of the present invention;

FIG. 7 is a block diagram illustrating an SSD controller illustrated in FIG. 6; and

FIG. 8 is a block diagram illustrating a computer system in which a data storage device according to an exemplary embodiment of the present invention is mounted.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, reference numerals correspond directly to the like parts in the various figures and embodiments of the present invention.

The drawings are not necessarily to scale and in some instances, proportions may have been exaggerated in order to clearly illustrate features of the embodiments. In this specification, specific terms have been used. The terms are used to describe the present invention, and are not used to qualify the sense or limit the scope of the present invention.

In this specification, ‘and/or’ represents that one or more of components arranged before and after ‘and/or’ is included. Furthermore, ‘connected/coupled’ represents that one component is directly coupled to another component or indirectly coupled through another component. In this specification, a singular form may include a plural form as long as it is not specifically mentioned in a sentence. Furthermore, ‘include/comprise’ or ‘including/comprising’ used in the specification represents that one or more components, steps, operations, and elements exists or are added.

Hereafter, the exemplary embodiments of the present invention will be described with reference to the drawings.

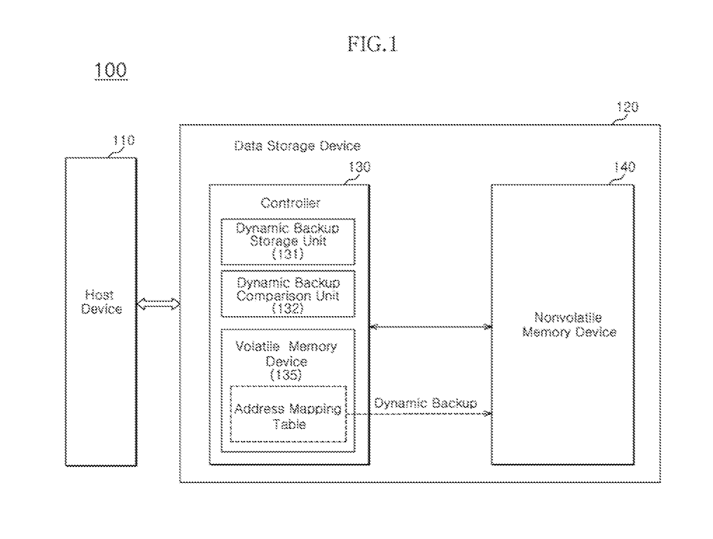

FIG. 1 is a block diagram illustrating a data processing system including a data storage device according to an exemplary embodiment of the present invention.

Referring to FIG. 1, the data processing system 100 may include a host device 110 and a data storage device 120.

The host device 110 may include portable electronic devices such as mobile phones, MP3 players and lap-top computers, or electronic devices such as desktop computers, game machines, TVs, beam projectors and car entertainment systems.

The data storage device 120 may operate in response to a request from the host device 110. The data storage device 120 may store data accessed by the host device 110. That is, the data storage device 120 may serve as a memory device of the host device 110. The data storage device 120 may be referred to as a memory system.

The data storage device 120 may include a controller 130 and a nonvolatile memory device 140. The controller 130 and the nonvolatile memory device 140 may be implemented with a memory device. Alternatively, the controller 130 and the nonvolatile memory device 140 may be implemented with a solid state drive (SSD). The memory device and the SSD may be coupled to the host device 110 through various interfaces.

The controller 130 may control overall operations of the data storage device 120. The controller 130 may execute firmware for controlling the overall operations of the data storage device 120. The firmware and data required for executing the firmware may be loaded into a volatile memory device 135 provided in the controller 130.

The controller 130 may include a dynamic backup storage unit 131 and a dynamic backup comparison unit 132, in order to perform a dynamic backup operation for an address mapping table according to the exemplary embodiment of the present invention. The dynamic backup storage unit 131 may manage or store the number of address mapping table segments containing changed address mapping information. The dynamic backup comparison unit 132 may store a backup reference value, and compare the number of the address mapping table segments containing the changed address mapping information with the backup reference value.

The volatile memory device 135 may store firmware and data required for the operation of the controller 130. That is, the volatile memory device 135 may operate as a working memory device of the controller 130. The volatile memory device 135 may temporarily store data to be transmitted from the host device 110 to the nonvolatile memory device 140, or transmitted from the nonvolatile memory device 140 to the host device 110. That is, the volatile memory device 135 may serve as a buffer memory device or cache memory device.

The controller 130 may control the nonvolatile memory device 140 in response to a request from the host device 110. For example, the controller 130 may provide data read from the nonvolatile memory device 140 to the host device 110, and may store data provided from the host device 110 in the nonvolatile memory device 140. For this operation, the controller 130 may control read, program (or write), and erase operations of the nonvolatile memory device 140.

The nonvolatile memory device 140 may perform a read or program operation in unit of page due to structural characteristics thereof. The nonvolatile memory device 140 may perform an erase operation in unit of blocks due to the structural characteristics thereof. Furthermore, the nonvolatile memory device 140 may not perform an overwrite operation due to the structural characteristics thereof. That is, a memory cell of the nonvolatile memory device 140, in which data is stored, may store new data after erasing the data stored in the memory cell. Because of such characteristics of the nonvolatile memory device 140, the controller 130 may execute additional firmware referred to as a flash translation layer (FTL).

The FTL may manage read, program, and erase operations of the nonvolatile memory device 140 so that the data storage device 120 operates in response to an access, e.g., read or write operation, requested from a file system of the host device 110. Furthermore, the FTL may manage an additional operation due to the characteristics of the nonvolatile memory device 140. For example, the FTL may manage a garbage collection operation, a wear-leveling operation, a bad block management operation, or the like.

When the host device 110 accesses the data storage device 120, for example, when a read or write operation is requested, the host device 110 may provide a logical address to the data storage device 120. The controller 130 may convert the logical address into a physical address used in the nonvolatile memory device 140, and perform the read or write operation based on the physical address. For this address conversion operation, an address mapping table including address conversion data may be required. The address mapping table may be managed by the FTL.

While the data storage device 120 operates, the address mapping table may be loaded into the volatile memory device 135. Since the address mapping table is required for driving the data storage device 120, the address mapping tables may be backed up into the nonvolatile memory device 140 from the volatile memory device 135.

The backup operation for the address mapping table may be performed when the operation of the data storage device 120 is finished or when the data storage device 120 is powered off. In this case, the entire address mapping table may be backed up. Furthermore, the backup operation for the address mapping table may be performed at the time at which backup is needed, for example, whenever address mapping information is changed. In this case, the entire address mapping table or only a part of the address mapping table, which contains changed address mapping information, may be backed up. Such a backup operation may be statically performed according to a backup schedule.

The backup operation for the address mapping table may be performed based on a comparison result of the dynamic backup comparison unit 132, which compares the number of the address mapping table segments containing the changed address mapping information with the backup reference value. The backup operation for the address mapping table may be immediately performed when the number of the address mapping table segments containing the changed address mapping information is greater than or equal to the backup reference value. The backup operation for the address mapping table may be dynamically performed when the condition based on the backup reference value is satisfied. Such a backup operation is referred to as a dynamic address mapping table backup operation or simply referred to as a dynamic backup operation.

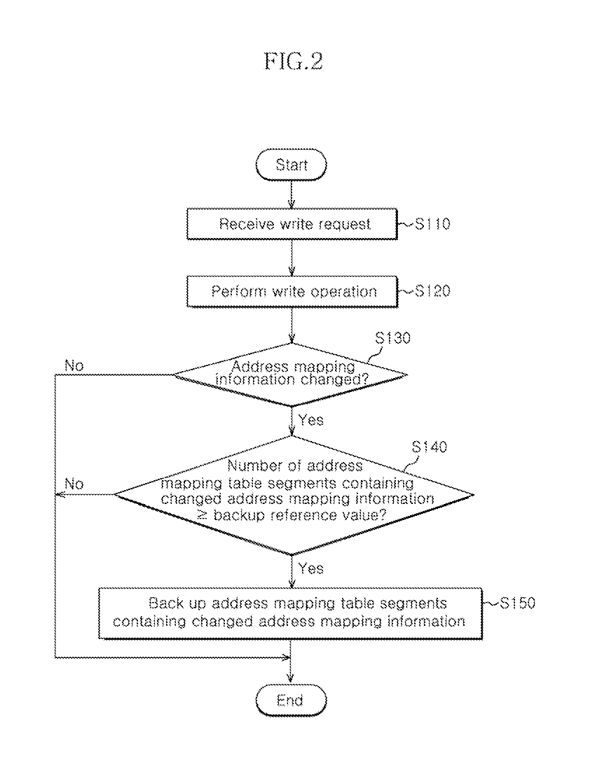

FIG. 2 is a flowchart explaining an operating method of a data storage device according to an exemplary embodiment of the present invention.

Referring to FIG. 2, a sequence of the dynamic backup operation, which is performed by the controller 130 of the data storage device 120 of FIG. 1 is explained.

At step S110 the controller 130 may receive a write request from the host device 110.

At step S120, the controller 120 may perform a write operation on the nonvolatile memory device 140 in response to the write request. While the write operation is performed on the nonvolatile memory device 140 in response to the write request, address mapping information may be changed. For example, while the write operation is performed, a physical address of the nonvolatile memory device 140, corresponding to a logical address provided from the host device 110, may be changed.

For example, the physical address corresponding to the logical address may be changed based on the structural characteristics of the nonvolatile memory device 140. For another example, the physical address corresponding to the logical address may be changed based on an operation algorithm for improving the performance of the data storage device 120, for example, a buffer programming using a buffer block or log block.

At step S130, the controller 130 may detect whether or not address mapping information is changed while the write operation is performed. For example, the controller 130 may detect whether or not there are address mapping table segments of which address mapping information is changed while the write operation is performed. When the address mapping table segments containing the changed address mapping information are detected, the address mapping table segments containing the changed address mapping information and the number of the address mapping table segments may be managed by the dynamic backup storage unit 131 of FIG. 1. That is, the address mapping table segments containing the changed address mapping information and the number of the address mapping table segments may be stored in the dynamic backup storage unit 131 under the control of the controller 130.

When address mapping information is not changed, the procedure may be ended because the backup operation is not needed. On the other hand, when the address mapping information is changed, the procedure proceeds to step S140, because the backup operation is needed.

At step S140, the controller 130 may determine whether or not the number of the address mapping table segments containing the changed address mapping information is greater than or equal to the backup reference value. For example, the dynamic backup comparison unit 132 in the controller 130 of FIG. 1 may compare the number of the address mapping table segments containing the changed address mapping information (that is, the information stored in the dynamic backup storage unit 131) with the backup reference value. When the number of the address mapping table segments containing the changed address mapping information is less than the backup reference value, the backup operation may not be performed, and lead to the end of the procedure shown in FIG. 2. For example, when the number of the address mapping table segments containing the changed address mapping information is less than the backup reference value, the backup operation may be delayed or postponed. On the other hand, when the number of the address mapping table segments containing the changed address mapping information is greater than or equal to the backup reference value, the procedure proceeds to step S150.

Although not illustrated, before the step S140 is performed, the controller 130 may change the backup reference value to adjust the frequency at which the backup operation for the address mapping table is performed. For example, the controller 130 may increase the backup reference value so that the backup operation for the address mapping table is performed once in a while. For another example, the controller 130 may decrease the backup reference value so that the backup operation for the address mapping table is performed frequently. The backup reference value set by the controller 130 may be stored in the dynamic backup comparison unit 132.

At step S150, the controller 130 may back up the address mapping table segments containing the changed address mapping information. For example, the controller 130 may sort address mapping table segments of which one or more pieces of address mapping information are changed, and back up the sorted address mapping table segments from the volatile memory device 135 into the nonvolatile memory device 140.

Through the steps S140 and S150, the controller 130 may compare the number of the address mapping table segments containing the changed address mapping information with the backup reference value, and may dynamically determine whether or not to back up the address mapping table segments containing the changed address mapping information, in response to the comparison result. The controller 130 may back up the address mapping table segments containing the changed address mapping information when the dynamic backup comparison unit 132 provides the comparison result indicating that the number of the address mapping table segments containing the changed address mapping information is greater than or equal to the backup reference value. The controller 130 may delay or postpone the backup operation for the address mapping table segments containing the changed address mapping information, when the dynamic backup comparison unit 132 provides the comparison result indicating that the number of the address mapping table segments containing the changed address mapping information is less than the backup reference value.

As described above, the controller 130 may perform the dynamic backup operation whenever the number of the address mapping table segments containing the changed address mapping information is greater than or equal to the backup reference value. According to the dynamic backup operation of the exemplary embodiment, a response speed to the write request may be improved further compared to when the entire address mapping table is collectively backed up after the write operation responsive to the write request is ended. Furthermore, according to the dynamic backup operation of the exemplary embodiment, the response speed to the write request may be improved further compared to when an address mapping table segment containing changed address mapping information is backed up whenever each address mapping table segment occurs.

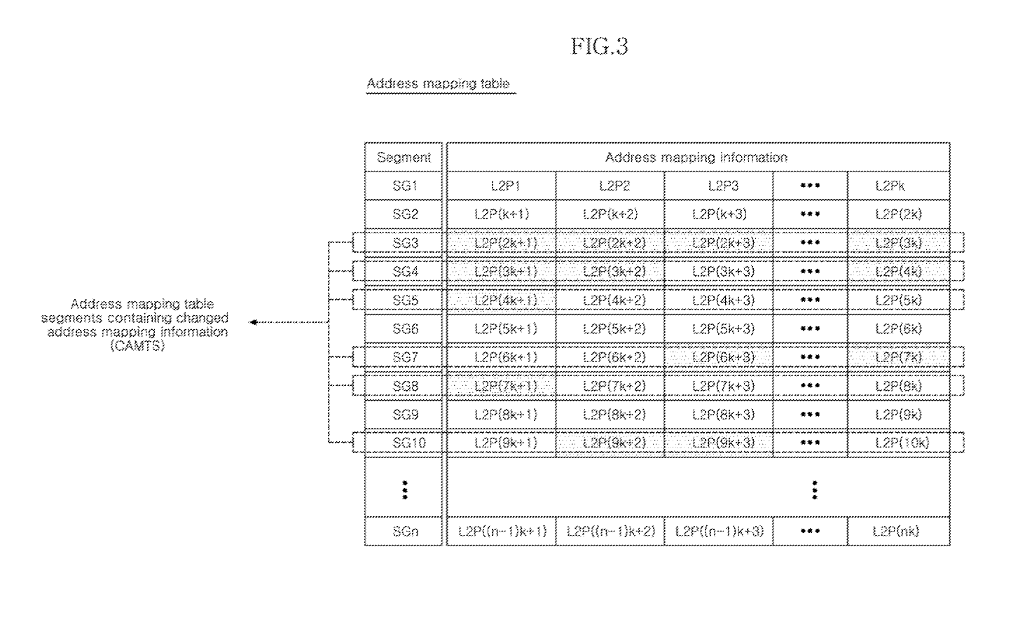

FIG. 3 is an address mapping table explaining address mapping table segments containing changed address mapping information according to an exemplary embodiment of the present invention.

The address mapping table may be divided by segments. That is, the address mapping table may include a plurality of address mapping table pieces, which are divided by the segments. The address mapping table pieces may be defined as address mapping table segments SG1 to SGn. The address mapping table may be loaded into the volatile memory device 135 of FIG. 1 in units of the segments.

Each of the address mapping table segments SG1 to SGn includes physical address information corresponding to a logical address, that is, address mapping information L2P. For example, as illustrated in FIG. 3, each of the address mapping table segments SG1 to SGn may include k pieces of the address mapping information L2P.

When one or more of the k pieces of the address mapping information L2P included in each of the address mapping table segments SG1 to SGn are changed, the respective address mapping table segments SG1 to SGn may be sorted as address mapping table segments containing changed address mapping information (hereinafter, referring to as ‘address mapping table segments CAMTS’). For example, an address mapping table segment SG3 of which all pieces of address mapping information L2P(2k+1) to L2P(3k) are changed may be sorted as the address mapping table segments CAMTS. For another example, an address mapping table segment SG4 of which three pieces of address mapping information L2P(3k+1), L2P(3k+2), and L2P(4k) are changed may be sorted as the address mapping table segments CAMTS. For another example, an address mapping table segment SG5 of which one piece of address mapping information L2P(4k+1) is changed may be sorted as the address mapping table segments CAMTS. For the same reason, address mapping table segments SG7, SG8, and SG10 may be sorted as the address mapping table segments CAMTS.

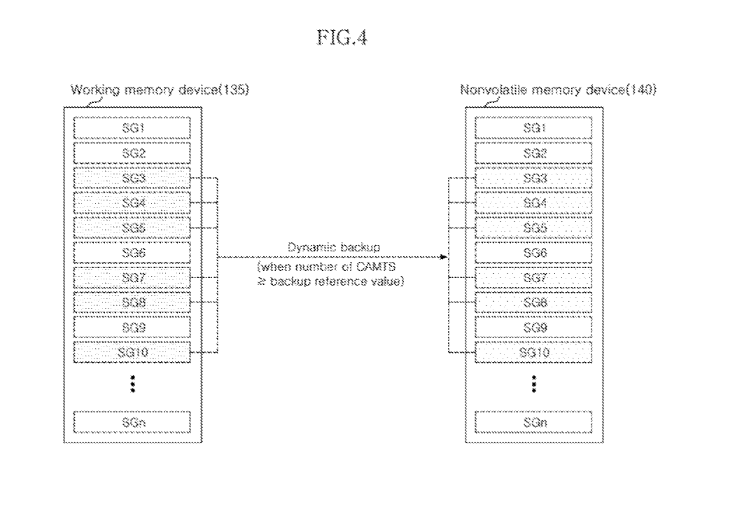

FIG. 4 is a diagram explaining the dynamic backup operation for the address mapping table according to an exemplary embodiment of the present invention.

Referring to FIG. 4, it is assumed that the backup reference value for determining whether or not to perform the dynamic backup operation is set to ‘5’. That is, when the number of the address mapping table segments CAMTS is greater than or equal to 5, the dynamic backup operation may be performed. Furthermore, the address mapping table segments SG3, SG4, SG5, SG7, SG8 and SG10 containing changed address mapping information in FIG. 3 will be taken as an example for describing the dynamic backup operation of FIG. 4.

The controller 130 of FIG. 1 may compare the number of the address mapping table segments CAMTS with the backup reference value. When determining that the number of the address mapping table segments SG3, SG4, SG5, SG7, SG8 and SG10 containing changed address mapping information, that is, 6, is greater than the backup reference value, that is, 5, the controller 130 may determine that the condition for performing the dynamic backup operation is satisfied.

The controller 130 may back up the address mapping table segments SG3, SG4, SG5, SG7, SG8 and SG10 containing changed address mapping information into the nonvolatile memory device 140 from the volatile memory device 135. Accordingly, the controller 130 may perform the dynamic backup operation whenever the number of the address mapping table segments CAMTS is greater than or equal to the backup reference value.

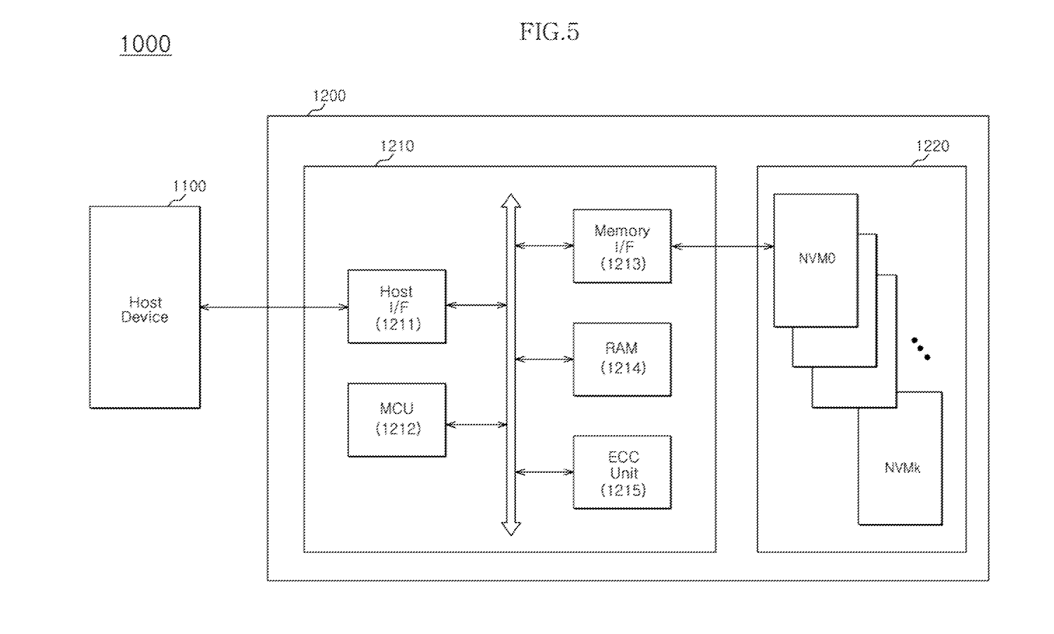

FIG. 5 is a block diagram illustrating a data processing system according to an exemplary embodiment of the present invention.

Referring to FIG. 5, the data processing system 1000 may include a host device 1100 and a data storage device 1200. The data storage device 1200 may include a controller 1210 and a nonvolatile memory device 1220. The data storage device 1200 may be coupled to the host device 1100 such as a desktop computer, a notebook computer, a digital camera, a mobile phone, an MP3 player, a game machine, or the like. The data storage device 1200 is also referred to as a memory system.

The data storage device 1200 may perform the dynamic backup operation according to the exemplary embodiment of the present invention. Thus, the performance of the data storage device 1200 may be improved.

The controller 1210 may access the nonvolatile memory device 1220 in response to a request from the host device 1100. For example, the controller 1210 may control a read, program, or erase operation of the nonvolatile memory device 1220. The controller 1210 executes firmware for controlling the nonvolatile memory device 1220.

The controller 1210 may include a host interface 1211, a micro control unit 1212, a memory interface 1213, a RAM 1214, and an ECC unit 1215.

The micro control unit 1212 may control overall operations of the controller 1210 in response to a request from the host device 1100. The RAM 1214 may serve as a memory of the micro control unit 1212. The RAM 1214 may temporarily store data read from the nonvolatile memory device 1220 or data provided from the host device 1100.

The host interface 1211 may interface the host device 1100 with the controller 1210. For example, the host interface 1211 may communicate with the host device 1100 through one of various interface protocols such as a Universal Serial Bus (USB) protocol, a Multimedia Card (MMC) protocol, a Peripheral Component Interconnection (PCI) protocol, a PCI-Express (PCI-E) protocol, a Parallel Advanced Technology Attachment (DATA) protocol, a Serial Advanced Technology Attachment (SATA) protocol, a Small Computer System Interface (SCSI) protocol, a Serial Attached SCSI (SAS) protocol, and an Integrated Drive Electronics (IDE) protocol.

The memory interface 1213 may interface the controller 1210 with the nonvolatile memory device 1220. The memory interface 1213 may provide a command and address to the nonvolatile memory device 1220. Furthermore, the memory interface 1213 may exchange data with the nonvolatile memory device 1220.

The ECC unit 1215 may detect errors of the data read from the nonvolatile memory device 1220. Furthermore, the ECC unit 1215 may correct the detected errors when the number of the detected errors falls within a correction range. Meanwhile, the ECC unit 1215 may be provided inside or outside the controller 1210 depending on the memory system 1000.

The controller 1210 and the nonvolatile memory device 1220 may be integrated into one semiconductor device to form a memory device. For example, the controller 1210 and the nonvolatile memory device 1220 may be integrated into one semiconductor device to form a personal computer memory card international association (PCMCIA) card, a compact flash (CF) card, a smart media card (SMC), a memory stick, a multi-media card (MMC, RS-MMC, or MMC-micro), a secure digital card (SD, Mini-SD, or Micro-SD), a UFS (universal flash storage) device, or the like.

As another example, the controller 1210 or the nonvolatile memory device 1220 may be mounted as various types of packages. For example, the controller 1210 or the nonvolatile memory device 1220 may be packaged and mounted according to various methods such as package on package (POP), ball grid arrays (BGAs), chip scale package (CSP), plastic leaded chip carrier (PLCC), plastic dual in-line package (PDIP), the in waffle pack, die in wafer form, chip on board (COB), ceramic dual in-line package (CERDIP), plastic metric quad flat package (MQFP), thin quad flat package (TQFP), small outline IC (SOIC), shrink small outline package (SSOP), thin small outline package (TSOP), thin quad flat package (TQFP), system in package (SIP), multi chip package (MCP), wafer-level fabricated package (WFP), and wafer-level processed stack package (WSP).

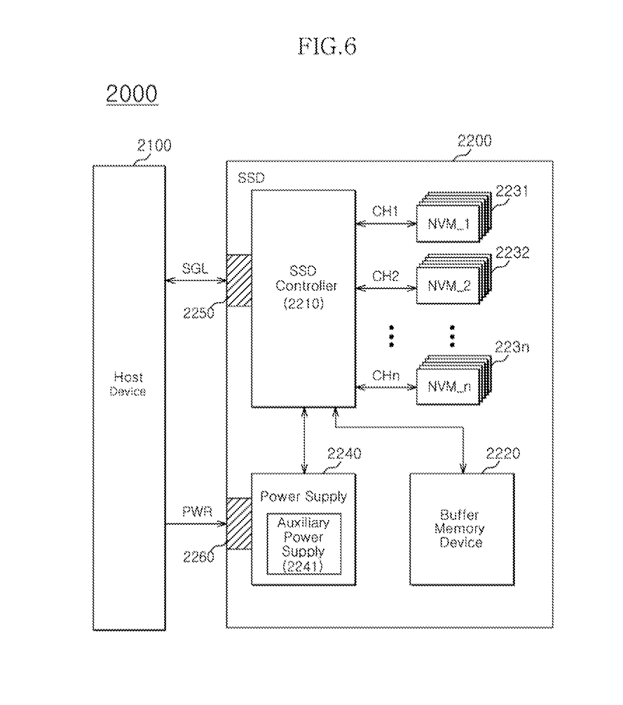

FIG. 6 is a block diagram illustrating an SSD according to an exemplary embodiment of the present invention.

Referring to FIG. 6, a data processing system 2000 includes a host device 2100 and an SSD 2200.

The SSD 2200 may include an SSD controller 2210, a buffer memory device 2220, a plurality of nonvolatile memory devices 2231 to 223n, a power supply 2240, a signal connector 2250, and a power connector 2260.

The SSD 2200 may operate in response to a request from the host device 2100. That is, the SSD controller 2210 may access the nonvolatile memory devices 2231 to 223n in response to a request from the host device 2100. For example, the SSD controller 2210 may control read, program, and erase operations of the nonvolatile memory devices 2231 to 223n. Furthermore, the SSD controller 2210 may perform the dynamic backup operation according to the exemplary embodiment of the present invention. Thus, the performance and operating speed of the SSD 2200 may be improved.

The buffer memory device 2220 may temporarily store data which are to be stored in the nonvolatile memory devices 2231 to 223n. Furthermore, the buffer memory device 2220 may temporarily store data read from the nonvolatile memory devices 2231 to 223n. The data temporarily stored in the buffer memory device 2220 may be transmitted to the host device 2100 or the nonvolatile memory devices 2231 to 223n, under the control of the SSD controller 2210.

The respective nonvolatile memory devices 2231 to 223n may serve as storage media of the SSD 2200. The respective nonvolatile memory devices 2231 to 223n may be coupled to the SSD controller 2210 through a plurality of channels CH1 to CHn. One channel may be coupled to one or more nonvolatile memory devices. The nonvolatile memory devices coupled to one channel may be coupled to the same signal bus and data bus.

The power supply 2240 may provide power PWR inputted through the power connector 2260 into the SSD 2200. The power supply 2240 includes an auxiliary power supply 2241. The auxiliary power supply 2241 may supply power to normally terminate the SSD 2200, when a sudden power off occurs. The auxiliary power supply 2241 may include super capacitors capable of storing the power PWR.

The SSD controller 2210 may exchange signals SGL with the host device 2100 through the signal connector 2250. Here, the signals SGL may include commands, addresses, data, and the like. The signal connector 2250 may include a connector such as a Parallel Advanced Technology Attachment (PATA), a Serial Advanced Technology Attachment (SATA), a Small Computer System Interface (SCSI), and a Serial Attached SCSI (SAS), according to the interface scheme between the host device 2100 and the SSD 2200.

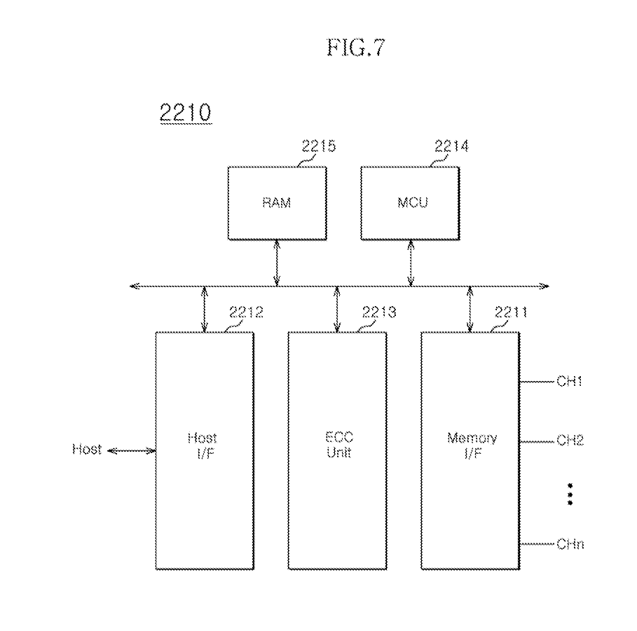

FIG. 7 is a block diagram illustrating the SSD controller shown in FIG. 6.

Referring to FIG. 7, the SSD controller 2210 includes a memory interface 2211, a host interface 2212, an ECC unit 2213, a micro control unit 2214, and a RAM 2215.

The memory interface 2211 may provide a command and address to the nonvolatile memory devices 2231 to 223n. Furthermore, the memory interface 2211 may exchange data with the nonvolatile memory devices 2231 to 223n. The memory interface 2211 may scatter data transferred from the buffer memory device 2220 over the respective channels CH1 to CHn, under the control of the micro control unit 2214. Furthermore, the memory interface 2211 may transfer data read from the nonvolatile memory devices 2231 to 223n to the buffer memory device 2220, under the control of the micro control unit 2214.

The host interface 2212 may interface the SSD 2200 with the host device 2100 in response to the protocol of the host device 2100. For example, the host interface 2212 may communicate with the host device 2100 through any one of a Parallel Advanced Technology Attachment (PATA), a Serial Advanced Technology Attachment (SATA), a Small Computer System Interface (SCSI), a Serial Attached SCSI (SAS) protocols, and the like. Furthermore, the host interface 2212 may perform a disk emulation function of supporting the host device 2100 to recognize the SSD 2200 as a hard disk drive (HDD).

The ECC unit 2213 may generate parity bits based on the data transmitted to the nonvolatile memory devices 2231 to 223n. The generated parity bits may be stored in spare areas of the nonvolatile memory devices 2231 to 223n. The ECC unit 2213 may detect errors of data read from the nonvolatile memory devices 2231 to 223n. When the number of the detected errors falls within a correction range, the ECC unit 2213 may correct the detected errors.

The micro control unit 2214 may analyze and process the signal SGL inputted from the host device 2100. The micro control unit 2214 may control overall operations of the SSD controller 2210 in response to a request from the host device 2100. The micro control unit 2214 may control the operations of the buffer memory device 2220 and the nonvolatile memory devices 2231 to 223n based on firmware for driving the SSD 2200. The RAM 2215 may serve as a memory device for executing the firmware.

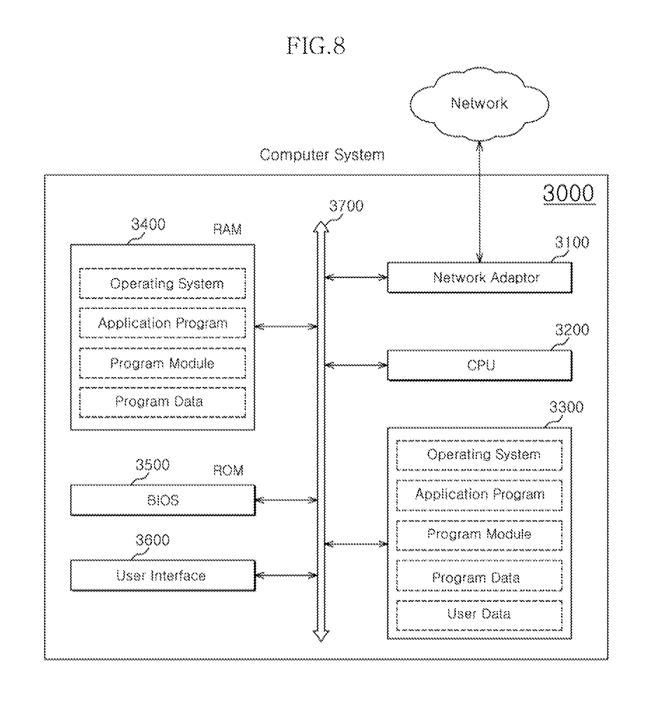

FIG. 8 is a block diagram illustrating a computer system in which the data storage device according to an exemplary embodiment of the present invention is mounted.

Referring to FIG. 8, the computer system 3000 may include a network adapter 3100, a CPU 3200, a data storage device 3300, a RAM 3400, a ROM 3500, and a user interface 3600, which are electrically coupled to the system bus 3700. Here, the data storage device 3300 may include the data storage device 120 illustrated in FIG. 1, the data storage device 1200 illustrated in FIG. 5, or the SSD 2200 illustrated in FIG. 6.

The network adapter 3100 may provide interfaces between the computer system 3000 and external networks. The CPU 3200 may perform overall arithmetic operations for driving an operating system or application programs residing on the RAM 3400.

The data storage device 3300 may store overall data required by the computer system 3000. For example, the operating system for driving the computer system 3000, application programs, various program modules, program data and user data may be stored in the data storage device 3300.

The RAM 3400 may serve as a memory device of the computer system 3000. During booting, the operating system, application programs and various program modules, which are read from the data storage device 3300, and program data required for driving the programs may be loaded into the RAM 3400. The ROM 3500 may store a basic input/output system (BIOS), which is enabled before the operating system, is driven. Through the user interface 3600, information exchange may be performed between the computer system 3000 and a user.

Although not illustrated, the computer system 3000 may further include a battery, application chipsets, a camera image processor (CIP), and the like.

While certain embodiments have been described above, it will be understood to those skilled in the art that the embodiments described are by way of example only. Accordingly, the data storage device described herein should not be limited based on the described embodiments. Rather, the data storage device described herein should only be limited in light of the following claims.

What is claimed is:

1. An operating method of a data storage device, the operating method comprising:
comparing the number of address mapping table segments containing changed address mapping information with a backup reference value; and
backing up the address mapping table segments containing the changed address mapping information in response to the comparison result.

2. The operating method according to claim 1, wherein the comparing the number of address mapping table segments containing changed address mapping information with the backup reference value comprises
determining whether or not the number of the address mapping table segments containing the changed address mapping information is greater than or equal to the backup reference value.

3. The operating method according to claim 2, wherein, when the number of the address mapping table segments containing the changed address mapping information is greater than or equal to the backup reference value, the address mapping table segments containing the changed address mapping information are backed up.

4. The operating method according to claim 1, further comprising:
detecting whether or not there are the address mapping table segments containing the changed address mapping information while an operation responsive to a request is performed.

5. The operating method according to claim 4, wherein the detecting whether or not there are the address mapping table segments containing the changed address mapping information comprises
managing the number of the address mapping table segments containing the changed address mapping information while the operation is performed.

6. The operating method according to claim 1, further comprising:
changing the backup reference value to adjust a frequency at which the backing up the address mapping table segments is performed.

7. The operating method according to claim 4, further comprising:
receiving a write request from a host device.

8. The operating method according to claim 7, further comprising:
performing a write operation on a nonvolatile memory device in response to the write request.

9. A data storage device comprising:
a nonvolatile memory device;
a volatile memory device suitable for storing an address mapping table divided into a plurality of address mapping table segments, in order to map a physical address of the nonvolatile memory device to a logical address provided from a host device; and
a controller suitable for controlling the nonvolatile memory device based on the address mapping table loaded into the volatile memory device in response to a request from the host device,
wherein the controller backs up address mapping table segments containing changed address mapping information into the nonvolatile memory device in response to a comparison result obtained by comparing the number of the address mapping table segments containing the changed address mapping information with a backup reference value.

10. The data storage device according to claim wherein the controller backs up the address mapping table segments containing the changed address mapping information from the volatile memory device into the nonvolatile memory device, when the number of the address mapping table segments containing the changed address mapping information is greater than or equal to the backup reference value.

11. The data storage device according to claim 9, wherein the controller delays a backup operation for the address mapping table segments containing the changed address mapping information, when the number of the address mapping table segments containing the changed address mapping information is less than the backup reference value.

12. The data storage device according to claim 9, wherein the controller detects whether or not the address mapping information of each of the address mapping table segments is changed.

13. The data storage device according to claim 12, wherein the controller sorts address mapping table segments containing one or more pieces of changed address mapping information, and manages the number of the sorted address mapping table segments.

14. The data storage device according to claim 9, wherein the controller comprises a dynamic backup storage unit suitable for storing the address mapping table segments containing one or more pieces of changed address mapping information and the number of the sorted address mapping table segments.

15. The data storage device according to claim 9, wherein the controller changes the backup reference value to adjust a frequency at which a backup operation for the address mapping table segments is performed.

16. The data storage device according to claim 9, wherein the controller comprises a dynamic backup comparison unit suitable for storing the backup reference value, and comparing the number of the address mapping table segments containing the changed address mapping information with the backup reference value.

17. A data storage device comprising:
a nonvolatile memory device; and
a controller suitable for controlling the nonvolatile memory device based on an address mapping table in response to a request from a host device,
wherein the controller comprises:
a storage unit suitable for storing the number of address mapping table segments containing changed address mapping information, and
a comparison unit suitable for comparing the number of the address mapping table segments containing the changed address mapping information with a backup reference value,
wherein the controller dynamically performs a backup operation for the address mapping table in response to a comparison result from the comparison unit.

18. The data storage device according to claim 17, wherein the controller backs up the address mapping table segments containing the changed address mapping information when the number of the address mapping table segments containing the changed address mapping information is greater than or equal to the backup reference value.

19. The data storage device according to claim 17, wherein the controller delays the backup operation for the address mapping table segments containing the changed address mapping information when the number of the address mapping table segments containing the changed address mapping information is less than the backup reference value.

20. The data storage device according to claim 17, wherein the controller adjusts a frequency of the backup operation by changing the backup reference value.
